(19) United States
(12) Patent Application Publication
(10) Pub. No.: US 2012/0323937 A1
(43) Pub. Date: Dec. 20, 2012

(54) BULK CREATE, UPDATE AND DELETE (CUD) DATABASE OPERATIONS FOR TABLE INHERITANCE

(75) Inventors: Jatan K. Modi, Issaquah, WA (US); Chunke Yang, Sammamish, WA (US); Zhonghua Chu, Redmond, WA (US)

(73) Assignee: MICROSOFT CORPORATION, REDMOND, WA (US)

(21) Appl. No.: 13/161,171

(22) Filed: Jun. 15, 2011

(51) Int. Cl. G06F 17/30

(52) U.S. Cl. 707/754; 707/E17.059

(57) ABSTRACT

Enterprise systems, methods and computer program products are disclosed for providing bulk create (insert), update and delete operations for table inheritance in an enterprise resource system using an object-oriented language supporting polymorphism. The computer implemented method comprises receiving a request for one of a create, update and delete operation with respect to data of first and second tables of an inheritance table hierarchy; creating a temporary table comprising a surrogate key and a record identifier; establishing a filter condition with fields from different tables in table inheritance; and one of creating, updating and deleting data from the different tables in table inheritance according to the filter condition. The process is implemented on an application object server including a compiler for the object-oriented language, a kernel instance and a data access layer.

### FIELD OF THE INVENTION

The present invention generally relates to enterprise computer systems and methods and more particularly to systems, methods and computer program products for facilitating bulk create, update, delete (CUD) database operations for table inheritance in an enterprise resource planning system operating on a specially programmed computer server.

### BACKGROUND

In today's technological environment, it is common for enterprises such as business organizations, schools, charitable organizations and government organizations to deploy private computer networks—intranets—to securely share such organization's information or network operating system within that organization. The term “intranet” is used in contrast to “internet”, which is a network between and among individuals and organizations, the most common of which is the global, public Internet. That is, an intranet is a network within an enterprise which sometimes refers only to an internal (private) website, but may be a more extensive part of the enterprise's information technology (IT) infrastructure. For example, in many enterprises, an employee may work from home and gain access to the enterprise via a portal requiring additional security hurdles such as synchronous keys for entry. An enterprise intranet may host multiple private websites and constitute an important component and focal point of internal communication with, and collaboration among, individual computer users associated/affiliated with the enterprise (e.g., students within a university, co-workers within a company, members of a governmental department or the like).

As individual computer users associated/affiliated with the enterprise perform various computer-based activities while logged into the intranet, these users may utilize enterprise resource planning (ERP) client/server systems as provided by the enterprise. One such system known as the Dynamics® AX 2009 ERP system available from Microsoft Corporation of Redmond, Wash. provides a database query server and associated application object server among other features. These are routinely accessed by a client, for example, to query the database for data contained in tables. The database may comprise a plurality of related tables of data, for example, related to everyday activities of the enterprise. A member of the enterprise may perform a query of the database for data that may be located in what are known as inheritance tables. Such tables may have a root table or a source table which may have associated tables or target tables with similar data and the like with similar data in an inheritance connection or inheritance hierarchy. For example, to perform a request, for example, to do one of create, update or delete data from one table of an inheritance table connected to a plurality of data inheritance tables having similar data, a known enterprise resource planning system may perform such operations individually and not in bulk.

In known enterprise systems, a create, update or delete data request may be processed each time a request is executed. For example, a change-based event or CUD event typically involves establishing a relationship between a plurality of identified tables and rules set up by users in an EventCUD table. A program module which may be referred to as an Alerts module logs changes to all tables where users have set up rules in the EventCUD table. When the CUD event processor is invoked, it processes any CUD records found in the EventCUD table by matching them to user's rules in the EventRule table.

This process can cause degradation in performance of the ERP system as a whole. For example, in the instance of inheritance tables, similar change, update and delete operations must be run several times to create (insert), update or delete data in connected inheritance tables. The same request may be executed on the database each time the request for one of a create, an update or a delete is run. In the case of a typical enterprise structure involving a client (making a CUD request), a server and a database, making the same request may lead to expensive network calls, time and resource consumption impacting the ERP system as a whole.

Class polymorphism may be described as a feature of certain programming languages such as C++, X++ and C# among other languages whereby a derived class inherits from a base class and so gains all the properties and events of the base class. This feature is known but not presently exploited for bulk CUD operations for table inheritance. C++ is believed to be the first programming language to introduce class polymorphism. X++ is an object language known from the Dynamics AX ERP system introduced above.

Fundamentally, there is a need in the art for providing for bulk processing of create, update and delete operations for table inheritance to avoid the degradation in performance so that the bulk processing of CUD requests may result in more efficient ERP system operation. Also, table inheritance, when one table may be the parent of another table and so on, may cause repetitive requests of the same tables and the same or similar request processes may need to be performed to complete CUD operations for table inheritance. Bulk processing of table inheritance CUD requests is needed to improve efficiency.

Thus, it may be known to provide a unique single table CUD request, however, what are needed are systems, methods and computer program products for adapting existing processes for bulk CUD database operations for table inheritance using class polymorphism.

### SUMMARY

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present invention meets the above-identified needs by setting up a run-time request system, method and computer program product for providing for bulk create, update and delete (CUD database operations for table inheritance using class polymorphism supported by, for example, such languages as C₊₊, X₊₊ and C# and other object-oriented and, potentially, non-object-oriented languages.

In an embodiment, an application object server (AOS) comprises an X₊₊ (or, for example, a C#) parser-compiler, a kernel instance (having an X₊₊ interpreter) and a data access layer for accessing a database whereby a plurality of associated tables of table inheritance may be created (data inserted), updated and/or deleted in bulk operations. The kernel instance of the application object server further supports cursors as will be described herein. A “cursor” may represent an instance of a table in a SQL (structured query language) select statement or a table inheritance hierarchy. Herein, “insert” will be used as a term of art to incorporate any request for creation of data or insertion of data into tables, especially, inheritance tables of an inheritance table hierarchy. The application object server may also comprise a record identification generator coupled to the data access layer. The data access layer of the application object server may comprise a table permissions framework and a structured query language server data provider. These structures of the application object server provide a system architecture for supporting bulk CUD database operations for table inheritance.

In a related embodiment, table inheritance data may be inserted, updated and deleted in a bulk operation by creating a temporary table referred to herein as a temporary or scratch table for the purpose of the bulk insert, update and delete request processing. The scratch table may have properties of being able to update fields in a source table and a target table and can specify filters from a base hierarchy such as a table inheritance hierarchy seamlessly. The kernel of the AOS may split the single table inheritance X₊₊ CUD statement into multiple structured query language (SQL) statements for each target table in a table inheritance hierarchy, for example, a hierarchal relationship among tables having similar data fields. Such a CUD X₊₊ statement request or statement may also contain fields from base tables in a where tree. As a result, an X₊₊ CUD statement for table inheritance may not be simply split into multiple SQL statements. An application developer writing X++ code in the Dynamics AX ERP system may write CUD X++ statements for a table inheritance hierarchy such that the filter condition (where tree) may contain fields across table inheritance. The filter condition, on the other hand, cannot guarantee return of the same result as individual update/delete operations on a target table because of the filter condition. Consequently, a two pass-operation may be performed whereby, in a first pass, the kernel, of an application object server (AOS), issues a set-based insert statement into the temporary or “scratch” table, inserts a single column with the value of a unique key or Surrogate key (also referred to herein as RecID or record identifier in the context of Dynamics AX) of all rows that meet the specified filter criteria. The kernel of the AOS then issues, for example, actual delete/update statements on target tables of the inheritance table hierarchy, i.e. into all target tables joined to the SQL temporary table on the Surrogate key.

In a related embodiment within Dynamics AX, the process involves a Surrogate Key of a root inheritance hierarchy inserted into a “scratch” table that may have the name SysSetbasedHelper or system set-based helper table and the surrogate key may have the name CandidateRecID or candidate record identifier which identify inheritance table rows that satisfy the filter criteria. The parent table may insert a candidate row's Record Identifier into the temporary or scratch table (system set-based helper table). The temporary table then deletes the candidate row's data in a Child table using table inheritance Record Identifier propagation. Now, the temporary table returns to the Parent Table to delete the candidate row's data in the Parent table using table inheritance Record Identifier propagation. The temporary table now has served its purpose of performing bulk CUD database operations for table inheritance.

Further features and advantages of the present invention, as well as the structure and operation of various embodiments of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a block diagram illustrating an exemplary intranet client server enterprise system according to an embodiment of the present invention wherein client devices may gain access to an application object server directly or via a report server, a host server or a web server; the application object server, in turn may access a database server through a data access layer as will be described with reference to FIG. 5.

FIG. 2A provides an overall structure of a plurality of data structures for update showing interplay among X₊₊ shown in the drawing as Xₚₚ, the Kernel of the AOS, namely tables A, B and C; FIG. 2B shows an example of a temporary or “scratch” table for bulk CUD table inheritance processing referred to herein as a system set based helper table including a candidate record identifier surrogate key; and FIG. 2C provides a plurality of exemplary data tables in an inheritance hierarchy for describing bulk data insertion, updating and deletion operations processes according to the present invention.

FIG. 3 is a block diagram of an exemplary computer system useful for implementing the present invention either as a client of FIG. 1 or server of FIG. 1 or FIG. 5.

FIG. 4 shows exemplary details of a process for a bulk inheritance table delete statement, for example, whereby a temporary scratch table is formed and interactions occur between parent and temporary, temporary and child and temporary and parent to accomplish a bulk CUD delete.

FIG. 5 is a further architecture diagram to that of FIG. 1 providing exemplary details of an application object server having a kernel instance, cursors, query generation, a data cache in a data access layer and a record identification generator for interaction with a database of FIG. 1 supporting bulk CUD database operations for table inheritance.

### DETAILED DESCRIPTION

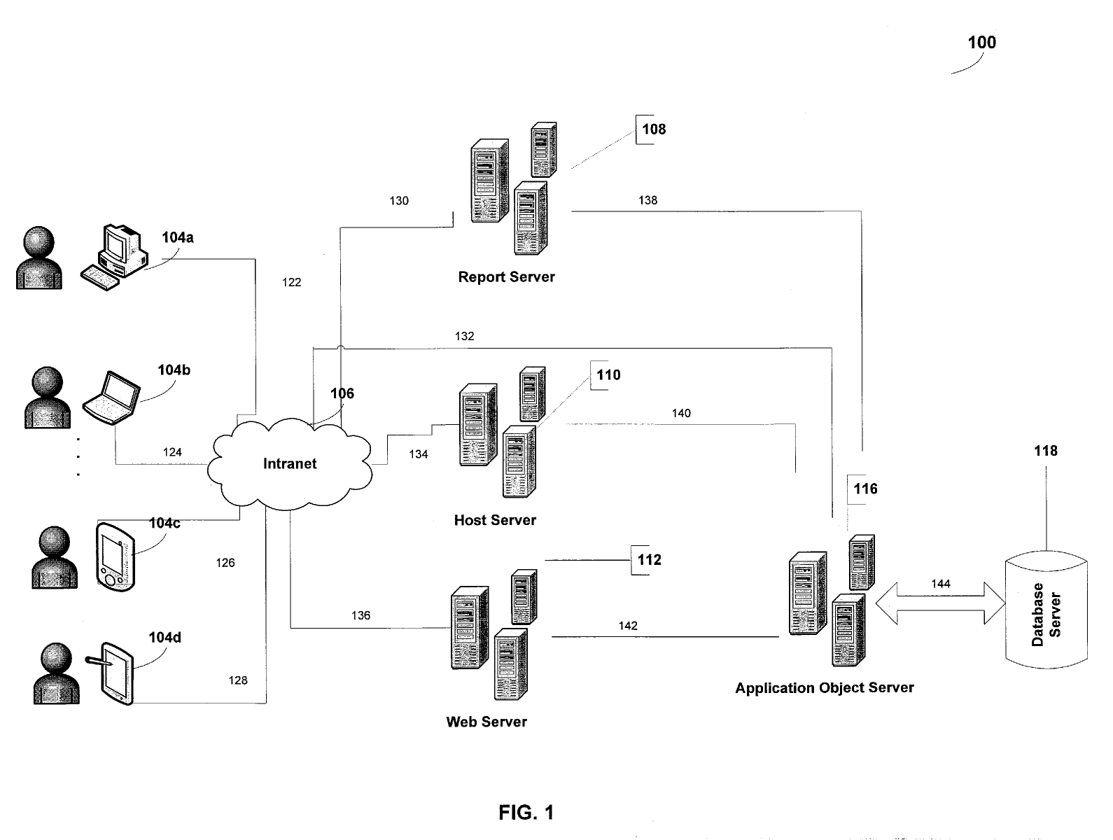

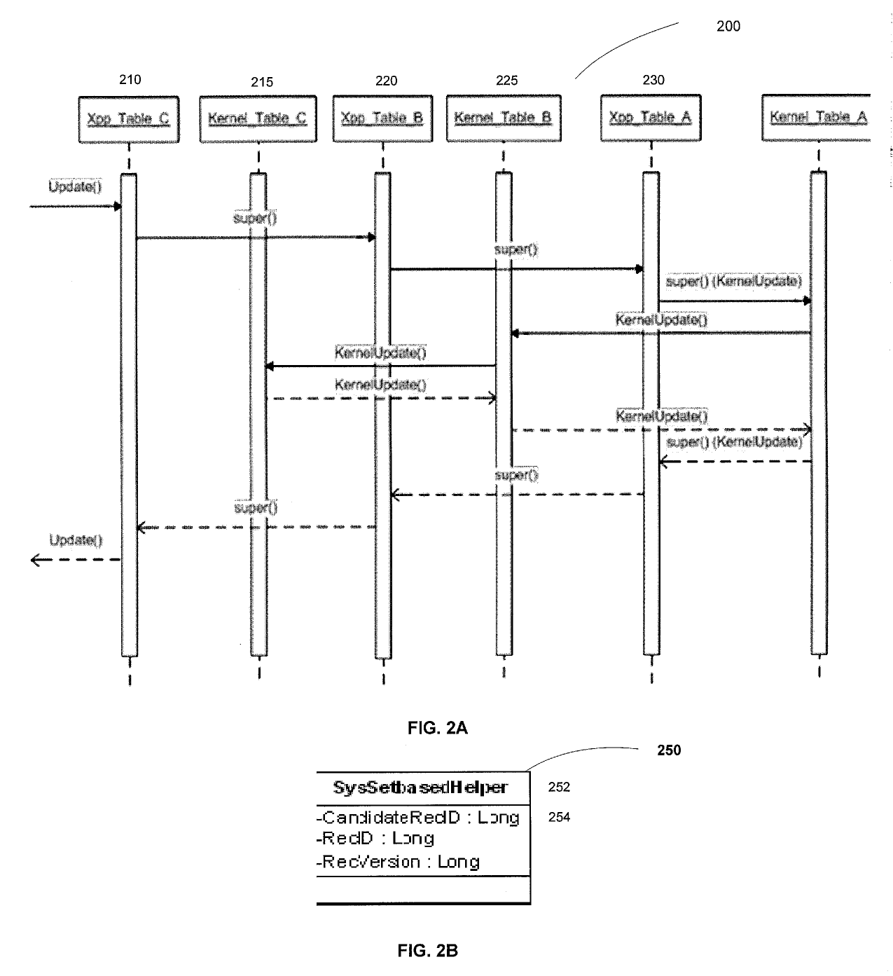

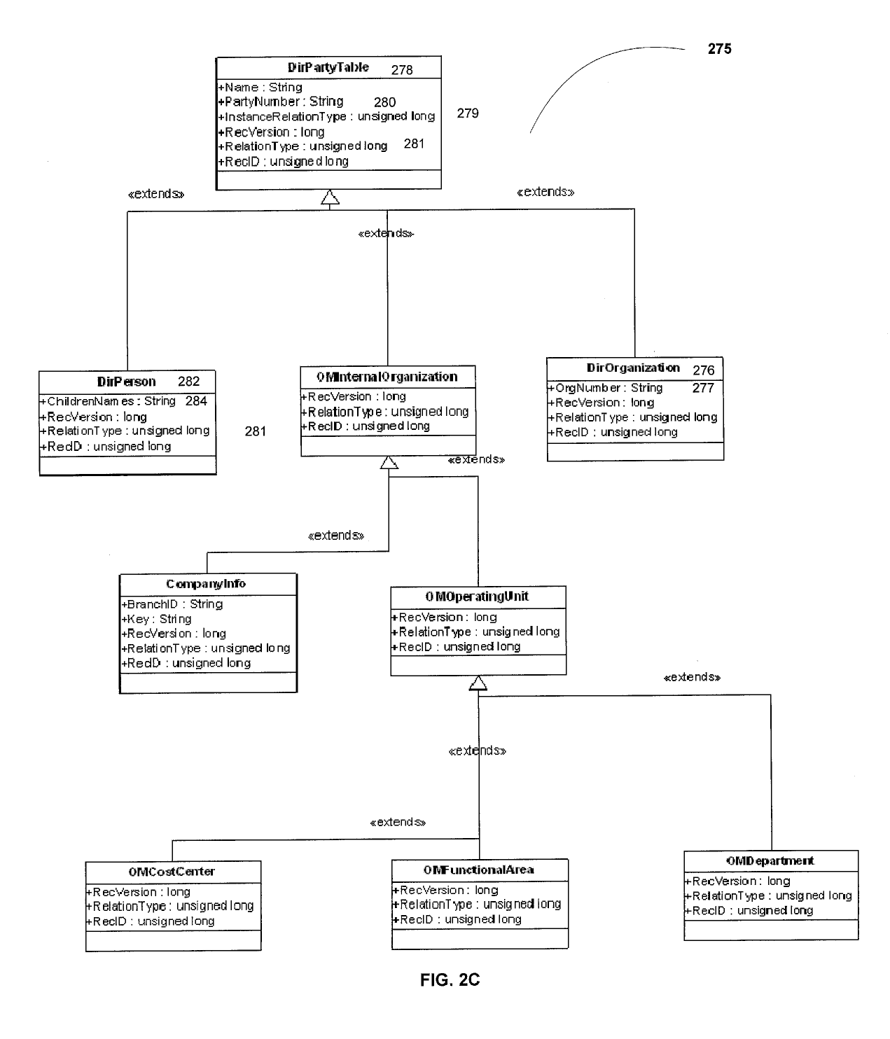

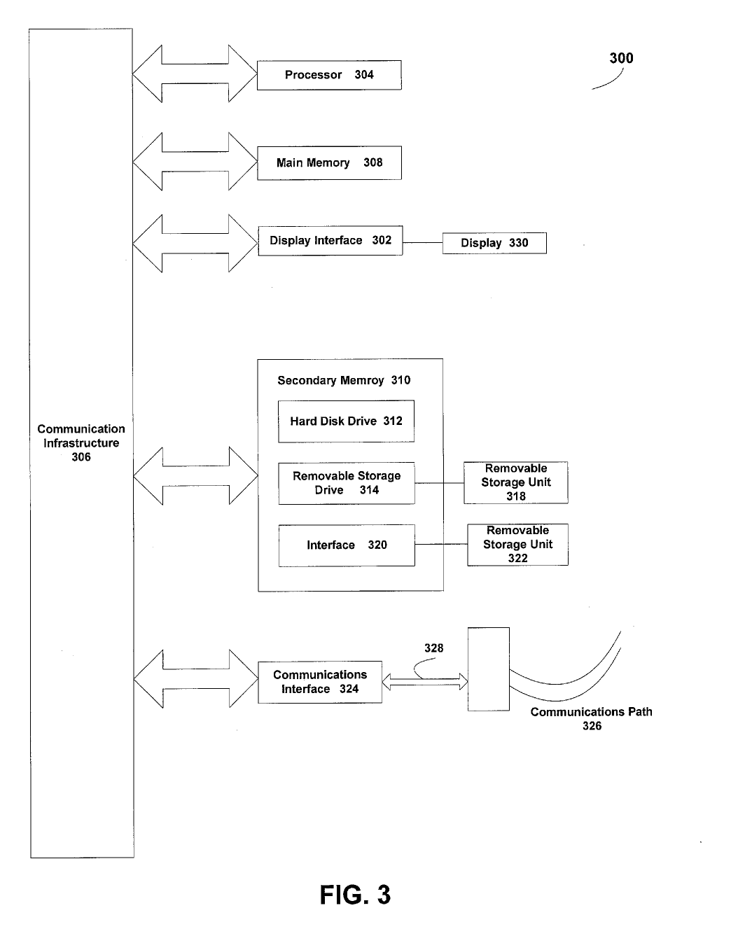

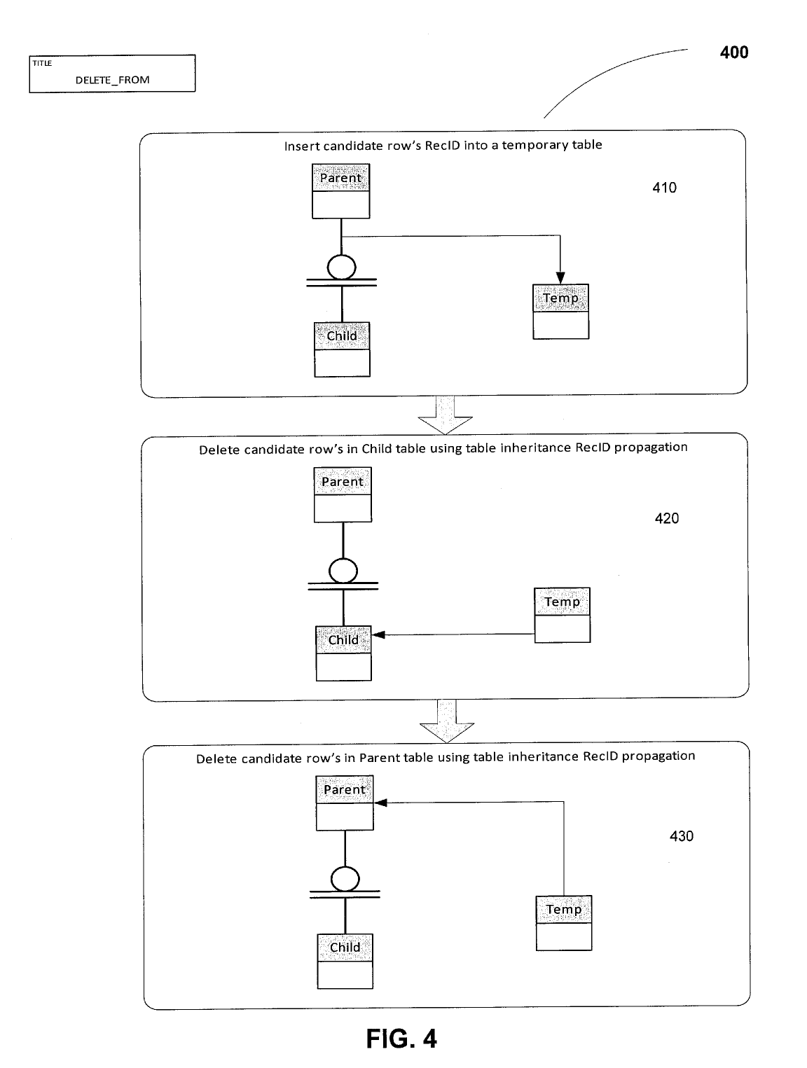

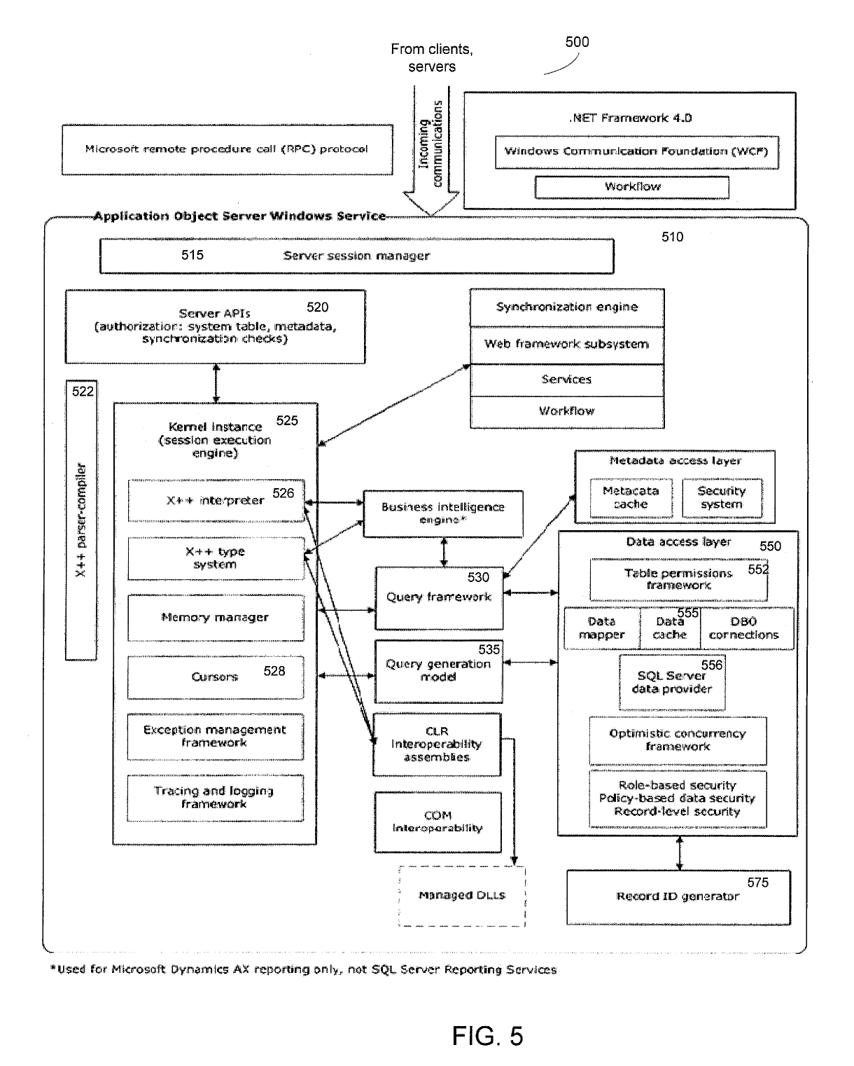

The present invention is directed to systems, methods and computer program products for facilitating bulk insert, update and delete database operations for table inheritance in an enterprise resource planning (ERP) system wherein an object-oriented language, such as X₊₊ or C# supports polymorphism. Firstly, we will provide an overview of bulk CUD database operations for table inheritance. During the overview, hardware figures FIG. 1, FIG. 3 and FIG. 5 will be introduced. A discussion of an exemplary process is depicted in FIG. 2A through 2C and 4.

Bulk insert, update and delete database operations for table inheritance in an enterprise resource planning (ERP) system is supported by a process described briefly as follows:

X++ supports bulk CUD operation whose syntax appears similarly to that below—

Update

| | |
|---|---|
| update_recordset | table |
| Setting | table.<<targetfield1> <new value1>, |
| | table.<targetfield2>.= <new value1> |
| | ... |
| Where | <filters on fields from table> |

Delete

| | |
|---|---|
| Delete_from | table |
| Where | <filters on fields from table> |

Insert

| | |
|---|---|
| Insert_into | table (targetfield1, targetfield2, ..., targetfieldn) |
| SELECT | field1,...,fieldn |
| FROM | sourcetable |
| Where | <filters on fields from sourcetable> |

In Update, there is typically an update statement, update_record or similar statement to update a record set in a table where there is a Setting of target field to new values in accordance with a Where, that is, filters on fields from the table. With the present invention, when a target table is part of table inheritance, then, the target table may have one or more fields from different tables to Update. The “ . . . ” of the Setting list simply represents that the update request may comprise several tables, several target fields and several new values to update beyond those identified above under Update.

In Delete, there may simply be a Delete_from or related statement or request from a client that will be applied to a table in accordance with a Where filter which filters on fields from the table to delete from. For Insert, the process involves an Insert_into or related operation, typically, where a table and a plurality of target fields 1 . . . n are identified. Following the Insert_into, there is a SELECT or related process of fields 1 . . . n selecting data from a source table (sourcetable) and applying a filter according to Where which filters on fields from the source table. Altogether, Update sets a value to a new value, Delete simply deletes and Insert may insert into selected fields from a source table, all according to a Where filter criteria.

In order to not sacrifice performance for table inheritance, X₊₊ (and C₊₊, C# and other object oriented languages) also may support bulk CUD operations for table inheritance. In the above example, the table can be a derived table in a table inheritance hierarchy which can update fields from the same table or from the base hierarchy and can specify filters from the same table or from the base hierarchy seamlessly. Since each backend structured query language (SQL) statement allows just one target table for a CUD operation, the Microsoft Dynamics AX kernel 525 (FIG. 5) of the application object server 116 (FIG. 1) may split a single table inheritance X++ CUD statement into multiple SQL statements for each target table in table inheritance. Such a CUD X++ statement can also contain fields from base tables in the where tree. As a result, an X++ CUD statement for table inheritance cannot be simply split into multiple SQL statements because of the fields from base tables of the where tree. Also, a filter condition cannot be guaranteed to return the same result as an individual update/delete operation on a target table which might have updated/deleted fields participating in the filter condition.

A simple example may illustrate the process further with reference to the table tree of FIG. 2C. Referring to FIG. 2C, there are shown a Direct Party Table 278 with fields 280 shown, for example, Name, Party Number, Instance Relation Type, Record Identifier and so on. There are also shown inheritance children tables of Table 278 such as Dir Organization table 276 and common fields 277, especially a Record Identifier field, unsigned long that links it to its parent and so on. All tables shown in FIG. 2C share Record Identifier unsigned long.

FIG. 2C suggests that an update and delete bulk operation for table inheritance may be a two pass operation where, in the first pass, a Microsoft Dynamics AX kernel 525 of an application object server 116 will issue a set-based insert statement into an intermediate ‘scratch’ table per FIG. 2B, for example, a System Set-based Helper table. Kernel 525 may insert a single column unique key or Surrogate key (also referred to herein as RecID or record identifier in the context of Dynamics AX) of all rows that meet the specified filter criteria. The kernel 525 may then issue an actual delete/update statement on each of the target tables for table inheritance joined to the SQL temporary table (FIG. 2B) on the Surrogate key (Candidate Record Identifier). Microsoft Dynamics AX 2012 may support a modeling capability of such SQL temporary tables (FIG. 2B) in X++ while other enterprise systems may use C# or other object oriented language or C₊₊. The table inheritance bulk operation implementation in Dynamics AX 2012 may use this SQL temp table infrastructure (FIG. 2B) under the hood as the ‘scratch’ table (FIG. 2B). The schema for the scratch table is shown in FIG. 2B as a System Set-based Helper table with Candidate Record Identifier (Surrogate key), Record Identifier and Record Version shown. Of these, Candidate Record ID may be the surrogate key value of rows that satisfy the filter criteria. A Record Version field may safely be ignored in the context of this document while Record Identifier may be used in each table of the inheritance hierarchy of FIG. 2C.

### Bulk Update and Delete Support for Table Inheritance

The following section describes bulk delete support for table inheritance. The update support is similar and omitted for sake of brevity. Below is a delete_from example:

delete_from DirOrganization

where DirOrganization.OrgNumber==VAL(OrgNumber) &&

DirOrganization. PartyNumber==VAL(PartyNumber)

In the above, the delete_from starts with DirOrganization table 276 of FIG. 2C. Dir Organization table 276 is seen in FIG. 2C while one filter condition applies to OrgNumber which may be a string 277 of FIG. 2C. The VAL(OrgNumber) is joined by operator && to a further table for PartyNumber shown as DirPartyTable 278 which includes PartyNumber:String 280. Consequently, the above exemplary X₊₊ Delete statement contains a filter condition with fields from different tables in table inheritance (FIG. 2C) which cannot be split into filter conditions specific to each individual table in the inheritance hierarchy (shown below), as it changes the semantics of the original X₊₊ delete statement.

```
    DELETE FROM DirOrganization
    WHERE OrgNumber= VAL(OrgNumber);
    DELETE FROM DirPartyTable
WHERE PartyNumber = VAL(PartyNumber);
```

So, a kernel 525 of an application object server will first issue an insert statement to insert a Surrogate Key of inheritance root which satisfies the filter criteria as follows:
Generated SQL Statement by a Microsoft Dynamics Ax 2012 SQL tempDB Framework:

INSERT INTO

tempdb.-
“DBO”.t30ED1BF8E8684416B39D87617C2775D3SysSetbasedHelper
(CandidateRecID)

| | |
|---|---|
| SELECT | t1.RECID |
| FROM | DirPartyTable as t1 CROSS JOIN DirOrganization |
| | as t2 |
| WHERE | (t2.OrgNumber= VAL(OrgNumber)) AND |
| | (t1.PartyNumber= VAL(PartyNumber)) AND |
| | (t1.RECID=t2.RECID) |

1^{st} statement: Insert candidate rows' RecID into SysSetbasedHelper's

CandidateRecID table

The INSERT INTO identifies a temporary or scratch table, for example, “System Set-based helper” table for the operation and identifies Candidate Record Identifier as the surrogate key. Temporary or scratch table generation is generated randomly, that is, a name “System Set-base helper” or other name may be randomly generated. On the other hand, once generated, the temporary or scratch table name may be unique.

The SELECT process looks for record identifier and shows FROM DirPartyTable 278 (FIG. 2C) and cross joined to DirOrganization table 276 (FIG. 2C). The WHERE shows that OrgNumber 277 (from DirORganization 276) and PartyNumber 280 (from DirPartyTable 278) are impacted by the process.

Now, the kernel 525 may issue a delete statement for each cursor 528 from a concrete cursor to inheritance root to delete only marked records. This is achieved by specifying a join between a current table and an inheritance root on RecID while filtering only records with marked RecID (Record Identifier) from the inheritance root as shown below. A last delete statement will operate on an inheritance root table to simply remove rows with the marked RecID.

```
  DELETE FROM DirOrganization
    WHERE EXISTS
      ( SELECT * FROM
    tempdb.“DBO”.-
    t30ED1BF8E8684416B39D87617C2775D3SysSetbasedHelper T1
      WHERE (DirOrganization.RECID= T1.CandidateRECID))
//2^{nd} statement: Delete candidate rows in DirOrganization using table
                  inheritance RecID propagation.
  DELETE FROM DirPartyTable
    WHERE EXISTS
      ( SELECT * FROM
    tempdb.“DBO”.-
    t30ED1BF8E8684416B39D87617C2775D3SysSetbasedHelper T1
      WHERE (DirPartyTable.RECID= T1.CandidateRECID))
        //3rd statement: Delete candidate rows in inheritance root.
```

So as per the above, DELETE FROM operates on DirOrganization table 276 (FIG. 2C) and the second DELETE FROM operates on DirPartyTable 278 starting from WHERE in each, namely Record Identifier (RECID) and identifying the System Set-based helper table (temporary table by name) in each SELECT FROM.

### Bulk Insert Support for Table Inheritance:

The syntax of a fictitious Insert X++ statement for BulkInsert for table inheritance is shown below

INSERT_RECORDSET DirPerson (Name, ChildrenNames)
SELECT field1, field2 from table1
WHERE t1.Field3 >= VAL(Field3)

Where fictitious table1 table's definition is as below

TABLE 1

+Field1 : String
+Field2 : String
+Field3 : Integer

Referring briefly again to FIG. 2C, DirPerson table 282 is identified in INSERT_RECORDSET where a Name of Children Names 284 are for insertion. Kernel 525 will leverage an existing SQL tempdb (temporary database) framework and simply use it for each table in the table inheritance. The sequence of such database operations is shown below.

| | |
|---|---|
| SELECT | T1.FIELD1 AS f1, T1.FIELD2 AS f2, |
| | 1 AS RECVERSION,IDENTITY(bigint,1,1) AS RECID |
| INTO | [#ax_tmp_dat3_53_0] |
| FROM | TABLE1 T1 |
| WHERE | (T1.FIELD3 >= VAL(Field3)) |

1st statement: Insert candiate rows from source tables into temp table

```
    INSERT INTO DirPerson
        (ChildrenNames,RelationType,RECVERSION,RECID)
    SELECT F1,0,RECVERSION,RECID+5637145077
    FROM [#ax_tmp_dat3_53_0]
    //2^{nd} statement: Insert into derived table(s) from mapped source table
fields. Note 0 as RelationType because DirPerson is the concrete table.
Kernel is automatically populating values for table inheritance linkage
(through RelationType)
    INSERT INTO DirPartyTable
        (Name,InstanceRelationType, RelationType,
        RECVERSION,RECID)
    SELECT F2,2975,2975,RECVERSION,RECID+5637145077
    FROM [#ax_tmp_dat3_53_0]
    //3^{rd} statement: Insert into inheritance root from mapped source table
fields. Kernel is automatically populating values for table inheritance
linkage (through RelationType and InstanceRelationType)
```

As indicated above, the first statement inserts candidate rows from a source table into a temporary or scratch table. The second statement inserts into derived table(s) (DirPerson 282 and DirPartyTable 278) from mapped source table fields. In SELECT for DirPerson, note that 0 as a RelationType because DirPerson 282 is the concrete table. The kernel 525 is automatically populating values for table inheritance linkage through RelationType in each of DirPerson table 282 and DirPartyTable 278. The third statement inserts into inheritance root from mapped source table fields. The kernel 525 is populating values for table inheritance linkage through RelationType 281 (DirPerson table 282) and through RelationType 281 InstanceRelationsType 279 (DirParty table 278). The kernel 525 Update operations 200 may likewise be seen in FIG. 2A starting and ending with a fictitious X₊₊ Table C to Kernel Table C and so on to start with a temporary table and conduct various update operations in fictitious tables linked by table inheritance such that all of tables A, B and C are eventually updated.

Referring now to FIG. 1, a block diagram illustrating an exemplary intranet enterprise resource planning (ERP) system 100 for an enterprise, according to an embodiment of the present invention, is shown.

Intranet enterprise requests, queries and database system 100 includes a plurality of users 104 (shown as users 104a-d in FIG. 1) of an enterprise accessing, via a respective computing device 104 (also, shown as devices 104a-d in FIG. 1), an organization's intranet (i.e., private network) 106 via wired or wireless communication links 122, 124, 126 and 128. Computing device 104 may be described herein as an organizational or enterprise member client. As will be appreciated by those skilled in the relevant art(s) after reading the description herein, Intranet 104 may be a private network deployed by an organization or enterprise such as a business enterprise for use by its employees. An enterprise system may, by way of example, be one for a university for use by its students and faculty, one for a government agency for its workers, and the like. As will also be appreciated by those skilled in the relevant art(s) after reading the description herein, system 100 may be deployed across one or more jurisdictions as, for example, a multinational business enterprise makes its intranet 106 available to its employees around the world. Such detail is not shown in FIG. 1.

In various embodiments, client device 104 may be configured as a desktop 104a, a laptop 104b, a PDA 104c, a tablet or mobile computer 104d, an intelligent communications device or the like. Device 104, in order to access private network 106 may typically have to identify a user name and password, if not, enter further security information such as a secret key or fingerprint data to access network 106. In accordance with an embodiment of a method of dynamically querying or making a CUD request of an enterprise database, a user may access a database 118 by user name and password, the user name and password being utilized by any of servers 108, 110 and 112 to access an application object server 116 or application object server 116 may be obtained directly by a client for in turn structuring the query/request to database 118 as will be briefly described with reference to FIG. 5.

FIG. 1 also shows communications media 122 for a desktop computer, 124 for a laptop, 126 for an intelligent mobile device, and 128 for a tablet computer. Communications media may be of any known form, wireless or wired, fiber optic, coaxial cable, satellite and the like and utilized at any location in a network 100 including media 130, 132, 134, 136, 138, 140, 142 and 144 to connect client devices 104 to servers, servers to servers and the like.

As users of client devices 104 log into an organizational/enterprise intranet 106, they perform various computer-based tasks while logged into the organization/enterprise's intranet 106. All these data may be categorized into categories, for example: data and commands associated with setting up a process for inventory control or other activity involving inserting, updating and deleting data in tables joined by conditions or as objects in an inheritance table hierarchy. With reference to FIG. 1, an enterprise server herein referred to as an application object server 116 may comprise a Dynamics® AX server running software available from Microsoft Corporation of Redmond, Wash. Oracle, IBM and other manufacturers of enterprise systems may provide similar database request services with their software and database product lines.

Referring now to FIG. 1, a client 104 may output queries, requests for database data insertions, updates, deletions, removals and the like of database 118 received as, for example, an X++ statement. X++ is an object-oriented language, similar to C#, used with Dynamics AX. (Other programming languages may be used as well, for example, C++ and related languages, wherein X++ is described herein by way of example.)

In an alternate embodiment to FIG. 1, application object servers 116 may employ a web interface server 112 (e.g., the SHAREPOINT® web platform available from Microsoft Corporation of Redmond, Wash.), a host server 110 or a report server 108 to allow intranet administrators and clients to manage an enterprise database 118. For example, such a web platform 112 can be used as a base and can allow for complete configuration and monitoring of system 100 such as the location of log files, data filtering and the like.

In an alternate embodiment, an intranet administrator would have access to configuration, status and data retrieval servers 118 via a web service-based application programming interface (API) (e.g., Simple Object Access Protocol (SOAP) or RESTful). In such an embodiment, the intranet administrator may enforce privacy laws and business rules based on access credentials. For example, an unprivileged user might be allowed to create, update or delete some data being accessed within intranet 106, while an authorized user (a manager or director or owner of a work queue) may transmit CUD requests for more restricted data and have additional authority for record management.

An example of a computer system 300 is shown in FIG. 3 which may either represent any client device 104 or any server of FIG. 1.

Computer system 300 includes one or more processors, such as processor 304. The processor 304 may be connected to a communication infrastructure 306 (e.g., a communications bus or network). Various software aspects are described in terms of this exemplary computer system. After reading this description, it will become apparent to a person skilled in the relevant art(s) how to implement the invention using other computer systems and/or architectures. Computer system 300 may represent a client device 104 possessed by an organization/enterprise member. Computer system 300 may similarly represent a server 108, 110, 112, 114 or 116 or database 118 as introduced in FIG. 1 and components thereof.

Database server 118 may be an SQL or other database server responsible for maintaining for example documents, organization charts, inventory data and the like for an enterprise. As such, as a document may be processed such as a purchase requisition, rules and parameters and conditions and the like may be retrieved by application object server 116 for use in bulk CUD database operations for table inheritance. While organization tables have been used by way of example in FIG. 2C, inheritance table hierarchies may be established around any categorized set of data only limited by the imagination.

Computer system 300 can include a display interface 302 that forwards graphics, text and other data from the communication infrastructure 306 (or from a frame buffer not shown) for display on the display unit 330. A display interface may be what a user sees on any one of client devices 104. A user may type or click or use other form of data or command entry to input data/commands for CUD operations to a dynamic database access system of the present invention.

Computer system 300 also includes a main memory 308, preferably random access memory (RAM) and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318 represents a floppy disk, magnetic tape, optical disk, etc. which is read by and written to by removable storage drive 314. As will be appreciated, the removable storage unit 318 includes a computer usable storage medium having stored therein computer software and/or data.

In alternative aspects, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of non-transitory signals 328 that flow over communications media 122, 124, 130, 132, 140 and so on which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, an radio frequency (RF) link and other communications channels as explained above.

In this document, the terms “computer program medium” and “computer usable medium” are used to generally refer to media such as removable storage drive 314, a hard disk installed in hard disk drive 312 and signals 328. These computer program products provide software to computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an embodiment where the invention is implemented using software, the software may be stored in a computer program product and loaded into computer system 300 using removable storage drive 314, hard drive 312 or communications interface 324. The control logic (software), when executed by the processor 304, causes the processor 304 to perform the functions of the invention as described herein.

Referring to FIG. 1, it will be assumed that a client device 104 has initiated a request for a database update or otherwise initiated an attempt to access data to insert, update or delete data of inheritance tables of a database 118. In so doing, the client request is received at application object server 600 and an associated statement is processed at kernel instance 525 (FIG. 5) as described above.

Referring to FIG. 5, cursors 528 comprise an element of the kernel instance 525 and may be coupled to a query generation model 535 of a business intelligence engine. Query framework 530 is coupled to kernel instance 525 as well and these provide two way communications with data access layer 550. Within data access layer 550 may be a data cache memory 655 where data may be cached depending on the result of process 500.

Referring further to FIG. 5, server API's 520 are shown in two-way communication with kernel instance 625.

Referring further to FIG. 5, there is shown a system architecture 500 for an application object server which supports bulk CUD database operations for table inheritance. Incoming communications are received from clients and other servers per FIGS. 1 and 3 which may comprise database related communications. There are shown the following elements of application object server 610: a server session manager 515 which may provide overall session management, server API's for various functions and features identified 520, and a kernel instance 525 and within kernel instance 525 there is cursors 528. The kernel instance 525 may be coupled to a data access layer 550 via a query framework 530 and a query generation model 535. Within the data access layer is a data cache 555 and a record ID generator 575.

As will be apparent to one skilled in the relevant art(s) after reading the description herein, the computer architectures shown in FIGs. 1, 3 and 5 may be configured as a desktop, a laptop, a server, a tablet computer, a PDA, a mobile computer, an intelligent communications device or the like. The X₊₊ programming language is one of many programming languages known as object-oriented languages that may be used and are known in the art of enterprise resource planning systems. Any of these architectures may be under the personal control of an organization or enterprise member, intranet administrator and the like and may be operated transparent to other database processes, for example, for data entry/retrieval of organization data, inventory data, purchase requisition data, request for proposal data, marketing and sales data and related organizational hierarchy data as well as other data relevant to CUD operations on data tables linked by inheritance to improve overall system efficiency according to inheritance table hierarchies and the use of a temporary scratch table and polymorphism as described above.

In yet another embodiment, the invention is implemented using a combination of both hardware and software and communications media may be wireless, wired or other form of communication recognizing any need for security of data of the enterprise.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures. For example, the systems, methods and computer program products for facilitating the querying of data of a database in an intranet environment may be also applicable to other networks such as internets.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A computer-implemented method configured to provide bulk create, update and delete database operations for table inheritance of a database in an enterprise, the computer-implemented method comprising:
receiving a request for one of a create, update and delete operation with respect to data of first and second tables of an inheritance table hierarchy;
creating a temporary table comprising one of a surrogate key and a record identifier;
establishing a filter condition with fields from different tables in table inheritance; and
one of creating, updating and deleting data from the different tables in table inheritance according to the filter condition.

2. The computer-implemented method of claim 1, further comprising:
a kernel issuing a statement and the one of the surrogate key and record identifier into the temporary table.

3. The computer-implemented method of claim 1, further comprising:
the temporary table comprising the record identifier;
a kernel issuing a join between a current table and an inheritance root according to the record identifier.

4. The computer-implemented method of claim 3, further comprising
if inserting is requested, inserting candidate rows' record identifier into the temporary table's surrogate key table.

5. The computer-implemented method of claim 3,
if deleting, deleting candidate rows in an inheritance table using record identifier propagation.

6. The computer-implemented method of claim 1,
if deleting, deleting candidate rows in an inheritance root.

7. The computer-implemented method of claim 1,
if inserting, inserting candidate rows from source tables into the temporary table.

8. The computer-implemented method of claim 1, further comprising:
if inserting, inserting into derived tables from mapped source table fields and
the kernel populating values for table inheritance linkage.

9. The computer-implemented method of claim 1,
if inserting, inserting into inheritance root mapped from mapped source table fields and
the kernel populating values for table inheritance linkage.

10. The computer-implemented method of claim 1 for implementation on an application object server, the application object server receiving incoming communications associated with an enterprise database and comprising a kernel instance, a query generation model and a data access layer.

11. A computer program product comprising computer usable medium encoded in a computer having control logic stored therein for causing the computer to provide bulk create, update and delete database operations for table inheritance of a database in an enterprise, said control logic comprising:
first computer readable program code means for receiving a request for one of a create, update and delete operation with respect to data of first and second tables of an inheritance table hierarchy;
second computer readable program code means for creating a temporary table comprising one of a surrogate key and a record identifier;
third computer readable program code means for establishing a filter condition with fields from different tables in table inheritance; and
fourth computer readable program code means for one of creating, updating and deleting data from the different tables in table inheritance according to the filter condition.

12. The computer program product of claim 11, further comprising:
the temporary table comprising the record identifier;
fifth computer readable program code means for issuing a join between a current table and an inheritance root according to the record identifier.

13. The computer program product of claim 11,
issuing a statement and the surrogate key into the temporary table.

14. A computer-implemented method configured to provide bulk create, update and delete database operations for table inheritance of a database in an enterprise, the computer-implemented method comprising:
receiving at an application object server a request for one of a create, update and delete operation with respect to data of first and second tables of an inheritance table hierarchy;
creating a temporary table, a kernel of the application object server issuing one of a surrogate key and a record identifier for the temporary table;
establishing a filter condition with fields from different tables in table inheritance; and
one of creating, updating and deleting data from the different tables in table inheritance according to the filter condition.

15. The computer-implemented method of claim 14, further comprising
the temporary table comprising the record identifier;
the kernel issuing a join between a current table and an inheritance root according to the record identifier.

16. The computer-implemented method of claim 15, further comprising
if inserting is requested, inserting candidate rows' record identifier into the temporary table's surrogate key table.

17. The computer-implemented method of claim 15, further comprising
if deleting, deleting candidate rows in an inheritance table using record identifier propagation.

18. The computer-implemented method of claim 14, further comprising
if deleting, deleting candidate rows in an inheritance root.

19. The computer-implemented method of claim 14, further comprising
if inserting, inserting candidate rows from source tables into the temporary table.

20. The computer-implemented method of claim 14, further comprising
if inserting, inserting into derived tables from mapped source table fields and
the kernel populating values for table inheritance linkage.
